(19) United States
(12) Patent Application Publication
(10) Pub. No.: US 2001/0034847 A1
(43) Pub. Date: Oct. 25, 2001

(54) Internet/network security method and system for checking security of a client from a remote facility

(76) Inventor: Stephen E. Gaul,Jr., Schnecksville, PA (US)

Correspondence Address: PEPPER HAMILTON, 600 FOURTEENTH STREET NW, WASHINGTON, DC, 20005, US

(21) Appl. No.: 09/817,347

(22) Filed: Mar. 27, 2001

Related U.S. Application Data
(60) Provisional application No. 60/192,365, filed on Mar. 27, 2000.

(51) Int. Cl. H04L 9/32

(52) U.S. Cl. 713/201; 709/225

(57) ABSTRACT

Methods and apparatus for network security systems, which are particularly suited for finding vulnerabilities to computer hacking and unauthorized entry is disclosed. An application of the network security system method and apparatus to computer networks is also disclosed for either an Internet-based system or an internal computer network system.

### PRIORITY

The following application claims priority from U.S. Provisional Application Ser. No. 60/192,365 filed on Mar. 27, 2000, the disclosure of which is incorporated herein by reference.

### FIELD OF THE INVENTION

The present invention relates generally to systems for testing computer network security. More particularly, the present invention relates to a network security system for testing computer network vulnerability to hacking or unauthorized entry.

### BACKGROUND OF THE INVENTION

Network security systems and other security products serve a number of purposes. One purpose is that of reducing or preventing the threat of computer hackers compromising a computer network which may contain sensitive customer or company data. This can be accomplished by using a series of in-house software programs to perform internal network security vulnerability scanning assessments and audits. Currently, the leading network security firms use software tools that check security from within a client's network. By reducing the threat of computer hacking and the like, customers or clients may feel more confident about supplying personal or other sensitive information to a company's computer network, e.g., e-commerce and e-business companies, credit card data processors, etc.

Numerous methods have been developed to improve network security. For example, various anti-virus software packages are presently being marketed to companies and consumers. This software can be costly and inefficient in that the anti-virus databases contained therein usually have to be updated regularly and are designed to act in a passive manner only after a security breach of some type has been detected, i.e., a computer virus has been found. Another option is to use consulting services which require an on-site visit to ascertain the vulnerabilities of a customer's computer network. These on-site visits are usually expensive and time consuming to perform on a regular basis.

For instance, Adaptive Network Security (ANS) tools is the category of technology that includes network scanners, intrusion detection and vulnerability assessment tools. At the present time there are several traditional commercial products, called Host-based, that do penetration testing. These are shrink-wrapped software that must be installed onsite, and all require some level of training to operate. Host-based products are susceptible to instant obsolescence because new hacking techniques are uncovered continuously. Additional maintenance and updates to the software are necessary to overcome this inherent problem. Some freeware host-based products are also available. The freeware is typically unsupported open source code and must be operated with little or no training.

For example, host-based Vulnerability Scanners include: Internet Scanner™ by Internet Security Systems (ISS); CyberCop™ by Network Associates Inc.(NAI); bv-Control™ by BindView Development Corp.; NetSonar Scanner™ by Cisco Systems Inc.; LanWatch™ by Precision Guesswork; Kane Security Analyst™ by Security Dynamics Technologies Inc.; WebTrends Security Analyzer™ by WebTrend Corp.; Retriever™ by L-3 network Security Ltd.; NetRecon™ by Axent Technologies (Axent was recently acquired by Symantec Corp.); and NetRetriever™ by Symantec Corp. Freeware vulnerability and/or port scanners include Nessus™ and NMAP™.

Network security systems may also serve the function of providing continual updates to a company's computer network in order to circumvent any unforeseen problems and/or breaches. However, present network security systems are expensive and highly dependent on either software packages which become quickly outdated or are costly to regularly update. Another network security service currently used is what is known as managed services which is often contracted to perform security breach testing on computer networks.

The managed service offering is a relatively new business model. One example of this is where the client requests that tests be performed and the managed service company runs the tests from their location. An e-mail is sent to the client informing them of the URL where the report can be viewed through a browser. The cost of this service is often determined by how many IP addresses are scanned. One such product costs over $6500 for a one-time scan of 100 addresses. Although it provides the client with up-to-date tests, the process is still controlled by the service and is extremely costly given that penetration tests should be run weekly and whenever the network configuration changes.

Managed Security Service offerings include: myCIO™ by Network Associates Technology, Inc. (NAI); Managed Security Services™ by Internet Security Systems, Inc. (ISS); HiveScan™ by Hiverworld; and VIGILANTe™ by VIGILANTe.com Inc.

Qualys™ is a French company that opened their US Headquarters in Silicon Valley in April 2000. The research & development staff resides in France. They offer an online, self-administered testing service called QualysGuard™.

The leading applications available today for network security penetration and vulnerability testing are dependent on the software's ability to have a continually updated security vulnerability database and the ease of implementation or access to the application. Today, security penetration and vulnerability testing software tools on the Windows NT and UNIX platforms are limited because they are only as good as the last vulnerability database update provided through conventional software distribution methods, or they are prohibitively priced for an organization performing assessments on an annual, semi-annual, or quarterly basis. They also require a significant investment in hardware and security related training of personnel.

While the currently developed network security systems and methods provide advantages over previous systems, they still suffer drawbacks. The primary drawback is the expense of using the managed services or software packages. Another drawback is that the software packages or managed services must be updated or performed regularly as mentioned above. A need still exists, therefore, for a network security system which can be used to prevent computer hacking or unauthorized entry into a computer network and which can be easily and inexpensively updated remotely thereby not requiring any on-site visits or any significant down time.

### SUMMARY OF THE INVENTION

The foregoing needs have been satisfied to a great extent by the present invention wherein, in one aspect of the invention, a network security system is provided having the advantages of: being accessed over the Internet through a web browser using an encrypted connection; providing customers with a simple, self-administered program/application to independently determine the vulnerability of their computer networks; eliminating the expense of special host equipment, together with software installation, updates, and maintenance; continuously adding new vulnerabilities and exploits to a scanning engine; using standard Common Vulnerabilities and Exposures (CVE) numbers and definitions; and being an Internet-based subscription service priced at a fraction of the cost of software packages and managed services currently available.

Thus, the present invention utilizes the emerging Application Service Provider (ASP) model for delivering network security penetration and vulnerability testing software. The present invention is also capable of using the Internet in the same manner that a computer hacker penetrates networks, thus the present invention will run from a data center and perform penetration testing on a user's network.

Therefore, the present invention will enable IT Managers, Network Managers, Systems Administrators, and Internal Audit personnel to perform an external Internet security vulnerability scanning assessment of a company's Internet firewalls, web-servers, email-servers, DNS servers, access routers, and all other Internet hosts. Since, the present invention is capable of being a web-based application service for Internet security vulnerability scanning software tools, with the initial Application Service Provider (ASP) feature of the invention targeting a company's external security issues, it is ideally situated in preventing computer hackers or unauthorized entry into a company's computer network.

Hence, the present invention is designed to allow IT Managers, Systems Administrators, Network Managers, and Internal Audit personnel to perform Internet security vulnerability assessments from outside their firewall. Thus, the present invention will offer clients a cost-effective way of testing, reporting and measuring the integrity of complicated network security architectures on an on-going basis.

Another aspect of the present invention is an ability to address a user's internal network security needs. This aspect of the present invention uses host-based application software that is a pre-configured hardware/software combination which can assess a company's internal network security needs. This turnkey hardware/software device can be installed on a company's internal network and used to perform an internal network assessment. This device may have expanded functionality to include non-vulnerability test security features like intrusion detection and real-time security monitoring.

Both aspects of the present invention rely heavily on a database of vulnerability and exploit tests. This database controls which tests are performed for a network, as well as provides information on how to fix a particular problem that is detected. When a new vulnerability is found the test is added to the database. The Internet-based aspect of the present invention allows customers to automatically run the new vulnerability tests the next time they use the service, while the internal security aspect of the present invention allows users to auto-update their database through a support web site.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is diagram of an embodiment of the present invention showing the relationship between the internal network security system features and external Internet-based network security system features of the invention.

FIG. 2 is a flow chart of a preferred embodiment of the present invention showing the encrypted login protocols of the network security system.

FIG. 3 is a flow chart of a preferred embodiment of the present invention showing the profiler application implementation step.

FIGS. 4a & 4b are flow charts of a preferred embodiment of the present invention showing the interrogator application implementation step with vulnerability test suites.

FIGS. 5a & 5b are flow charts of a preferred embodiment of the present invention showing the exploiter application implementation step with vulnerability test suites.

FIG. 6 is a flow chart of a preferred embodiment of the present invention showing the war dialer application implementation step.

FIG. 7 is a flow chart of a preferred embodiment of the present invention showing the analyzer application implementation step.

FIG. 8 is a flow chart of a preferred embodiment of the present invention showing the security test application implementation step.

FIG. 9 is a flow chart of a preferred embodiment of the present invention showing the reporter application implementation step.

### DETAILED DESCRIPTION OF PREFERRED EMBODIMENTS OF THE INVENTION

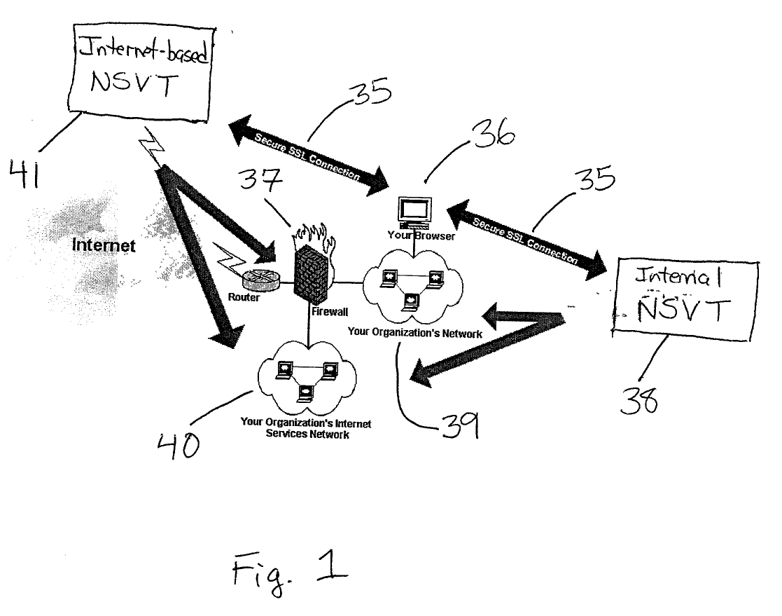

Referring now to the figures, wherein like reference numerals indicate like elements, in FIG. 1 there is shown an external Internet-based Network Security Vulnerability Testing (NSVT) application 41 and an internal NSVT 38. Both of these systems may have encrypted connections 35 to a user's workstation browser 36. One of the first stages of both systems is to inform the user about their own company's computer network or systems to be tested. Thus, both systems report back to the user about host information on a given subnetwork 39, 40. The user then launches security testing against any one system or multiple systems within their subnetwork. This testing can in most cases include multiple attempts at breaking security locks involving firewall 37 and other hosts. Security tests performed during this invasive phase DO NOT execute the damaging exploit if found. The testing will merely report the results as vulnerabilities that need to be addressed or at least made aware to the user.

Application Design Functionality and Specifications

The Network Security Vulnerability Testing (NSVT) application 41 is the main application used to run the Vulnerability Test Suites (VTS) 106 that communicate between the remote Client running the application and the Server performing the vulnerability scans on the destination/target device. The NSVT 41 is a custom written hypertext transport protocol (HTTP) based web server with additional custom written common gateway interface (CGI) modules that have the following basic functionality: provide a secure socket layer (SSL) connection to the client; maintain Session information concerning each client attached to the System; authenticate the user via the Login application; call appropriate programs on the server from the front-end application; push messages from the Server application to the client browser; and create HTML and ASCII files for each job.

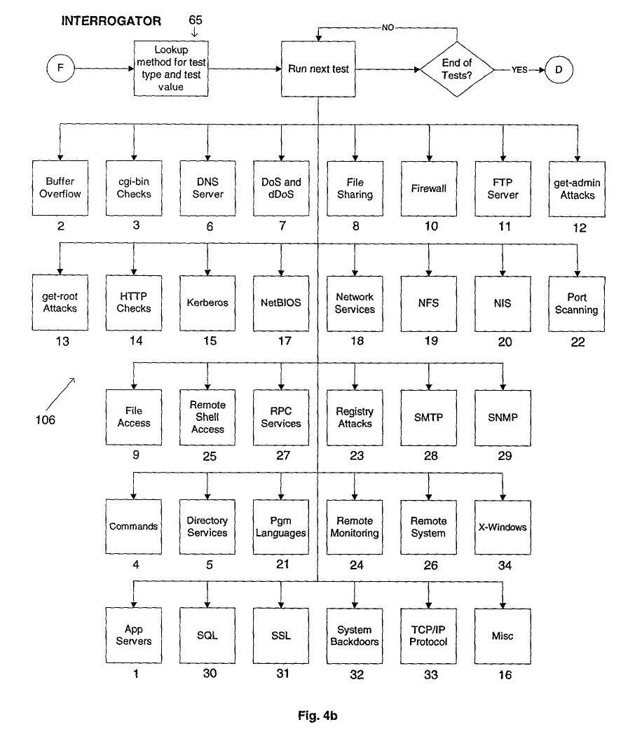

The Vulnerability Test Suites (VTS) 106, shown in FIGS. 4b & 5b, run on the Server performing the vulnerability scans on the destination/target device and communicate back to the remote Client running the application. The process of the Server performing the vulnerabiltiy scans and running the VTS is referred to as the Vunerabiltiy Scanning Engine (VSE). The VTS 106 components are as follows: (1) Application Servers Attacks, (2) Buffer Overflow Attacks, (3) CGI-bin checks on web servers, (4) Commands, (5) Directory Services, (6) DNS servers, (7) Denial of Service Attacks, (8) File Access, (9) File sharing, (10) Firewalls, (11) FTP Server, (12) get-admin attacks, (13) get-root attacks, (14) HTTP checks on web servers, (15) Kerberos, (16) Miscellaneous Vulnerability Testing, (17) NetBIOS, (18) Network Services, (19) Network File System (NFS), (20) Network Information Services (NIS), (21) Programming Languages, (22) Port scanning, (23) Registry attacks, (24) Remote Monitoring, (25) Remote system shell access, (26) Remote system access, (27) Remote Procedure Call (RPC) services, (28) Simple Mail Transport Protocol (SMTP) systems, (29) Simple Network Management Protocol (SNMP) systems, (30) Standard Query Language (SQL), (31) Secure Socket Layers (SSL), (32) System backdoors, (33) TCP/IP protocol attacks, and (34) X-Windowing Systems.

Vulnerability Test Suites

The Vulnerability Test Suites (VTS) 106 run on the Server performing the vulnerability scans on the destination/target device and communicate back to the remote Client running the application. The following are descriptions and details on each of the VTS 106 modules functionality and operations:

Application Server Attacks 1 are performed by testing the features that are found in application servers such as transaction management, clustering and fail-over, and load balancing. Application servers are designed to help make it easier for developers to isolate the business logic in their projects and develop three-tier applications, so in order for the VSE to perform a vulnerability check on a given application server, the VSE looks up in the program database any Application Server vulnerabilities that it has recorded and then attempts to create a connection to the remote node being scanned. Once a connection is established, the VSE determines what type of application server it is dealing with by analyzing the remote nodes response string to the connection request. The VSE then sends data to the remote node and attempts to run a specific function of that application server. The response from the remote node is then recorded as either being positive or negative, that it did not receive a response and either timed out or sent an error message back to the VSE application.

Buffer Overflow Attacks 2 are performed by inserting more data into an operating system or application programs buffer (holding area) than it can handle. This may be due to a mismatch in the processing rates of the producing and consuming buffers or because the buffer is simply too small to hold all the data that must accumulate before a piece of it can be processed. To perform a vulnerability check for a buffer overflow, the VSE looks up in the program database any known Operating System or Application buffer overflows that it has recorded and then attempts to create a connection to the remote node being scanned and then sends larger than normally expected amounts of data to the remote node and attempts to insert the data into a remote node operating system service or application program buffer. The response from the remote node is then recorded as either being positive, that the remote node would accept the oversized data or negative, that it did not and either timed out or sent an error message back to the VSE application.

CGI-bin Checks 3 are for the Common Gateway Interface (CGI) standard for interfacing external applications with information servers, such as HTTP or web servers. A CGI program check is executed by the VSE creating a TCP/IP connection to a web server and constructing a Universal Resource Locator (URL) with this connection that calls a CGI-bin program and tests for it's existence. CGI programs by design output dynamic information, so when the VSE connection that calls a CGI-bin program is made the response from the remote node is then recorded as either being positive or negative, that it did not produce any dynamic output and either timed out or sent an error message back to the VSE application.

Commands 4 or the ability to run unauthorized or priveledged commands on a remote node is tested by the VSE using an authentication scheme based on reserved port numbers. It is assumed that an AF_INET socket is returned from the remote node to the VSE. If the node being tested allows remote command execution, then the remote node application will choose which type of socket is returned by passing in the address family, either AF_INET or AF_INET6. If the connection succeeds, a socket in the Internet domain of type SOCK_STREAM is returned to the VSE, and given to the remote command as its standard input (file descriptor 0) and standard output (file descriptor 1). The control process will return diagnostic output from the command (file descriptor 2) on this channel, and will also accept bytes on this channel as signal numbers, to be forwarded to the process group of the command. If the remote node does not respond, then the standard error (file descriptor 2) of the remote command will be made the same as its standard output and no provision is made for sending arbitrary signals to the remote process. The response from the remote node is then recorded as either being positive or negative that it sent an error message back to the VSE application.

Directory Services 5 vulnerability testing is performed by the VSE attempting to obtain a directory listing of information about objects arranged in some order that gives details about each directory object found in a data repository on the remote node. The VSE attempts to interact with the directory service on the remote node by creating a session handle using the standard Lightweight Directory Access Protocol (LDAP) initialization call. The underlying session is established upon first use, which is commonly an LDAP bind operation. Next, other operations are performed by calling one of the synchronous or asynchronous routines. Results returned from these routines are interpreted by calling the LDAP parsing routines. The LDAP association and underlying connection is terminated by calling the LDAP unbind operation. The response from the remote node is then recorded as either being positive or negative that it sent an error message back to the VSE application.

Domain Name Server (DNS) 6 checks are performed by creating both TCP and UDP based TCP/IP connections to a remote node on port number 53. If the remote node responds back to the connection, then the VSE determines if the server supports IQUERY and then attempts to QUERY the server to determine what version of DNS and BIND it is running. The version returned from the QUERY string is then compared to the VSE program database of DNS and BIND versions that are known to have security problems. If the returned version matches then the node being tested, then it is recorded as positive.

Denial of Service Attacks (DoS) 7 will attempt to overrun a remote device with continuous streams of poorly formed IP packets. The VSE generates what appear to be normal messages, such as the User Datagram Protocol (UDP) packets, Transmission Control Packets (TCP) or Internet Protocol packets (IP). In the case of a UDP DoS attack, these packets claim to come from the same server that's receiving them. In the case of TCP and IP DoS attacks, the VSE fragments or incorrectly sizes the packets being sent. In trying to respond to this influx of miscommunication, the remote node being tested eventually becomes unable to accept any more connections. At this point, this test is recorded positive and the influx of miscommunication ceases.

File Access 8 vulnerability testing is performed by the VSE by attempting to access any file on a system as an unprivileged user without the proper access permissions by using a remote command, remote procedure call or HTTP GET in the case where the remote node is a web server. If the remote node is properly configured, this test should fail, however if the VSE can remotely obtain a file system through either of these methods, then the test is recorded as positive.

File Sharing 9 vulnerability testing is performed for both Network File System (NFS) and Common Internet File System (CIFS) architectures. In the case of NFS, the VSE will try to mount any shared file system via the portmapper service and as an unprivileged user. If a NFS server is properly configured, both of these tests should fail, however if the VSE can remotely mount a shared file system through either of these methods, then the test is recoded as positive. In the case of CIFS or what is part of the NetBIOS file sharing service, the VSE will attempt to retrieve all information available from the remote server using NetBIOS connection protocols and attempt to access any services provided by the server. If the VSE can remotely access any of these services without proper authentication or with weak authentication, then the test is recorded as positive.

Firewall 10 vulnerability testing will attempt to determine if a system or group of systems enforce an access control policy between two networks. The VSE firewall tests work as a pair of mechanisms, one that tests if network traffic is blocked, and the other that determines if network traffic is permitted. If properly configured a firewall will implement some type of access control policy. The VSE will attempt to recognize the firewall's configuration and access control policy by sending IP packets and connection attempts to the firewall to see if the packets are permitted or denied. The responses from the remote node are then recorded and a determination is made as either being positive or negative regarding the firewall type and functionality.

FTP Server 11 vulnerability testing is performed by the VSE creating a TCP/IP connection to a remote node on the standard FTP ports 20/tcp and 21/tcp. If the remote node responds back to the connection, then the VSE will atempt to compromise FTP security. The VSE will instruct the remote node to transfer files to a third machine, the VSE. This third-party mechanism, known as proxy FTP, causes a well-known security problem. An improperly configured FTP server allows an unlimited number of attempts at entering a user's password. This allows brute force “password guessing” attacks. The VSE also attempts to determine if the server supports anonymous or authenticated logins and then attempts to QUERY the server to determine what version of FTP it is running. The version returned is then compared to the VSE program database of FTP versions that are known to have security problems. If the returned version matches then the node being tested and it is recorded as positive.

Get-admin or Get Administrative Control 12 attack testing is accomplished by the VSE attempting to gain unauthorized administrative access to a remote node runing the Microsoft Windows™ Operating system. The VSE will attempt to connect to the remote node and perform administrative functions using a socket connection on ports 135/tcp, 137/tcp and/or 139/tcp. If the remote node is properly configured, administrator security should have been granted through membership in the administrators group. By default, the administrator on a particular computer is granted administrative permissions on that computer. The administrators group is a local group on the remote node and only members of this group should be able to perform administrative functions on the remote node. When the VSE is connected to a remote through an application or service, it will attempt to gain full read access to files, applications and services on the remote node. The responses from the remote node are then recorded and a determination is made as either being positive or negative regarding if the administrative access can be obtaineded without proper authentication or with weak authentication.

Get-root or Get Root Privilege 13 attack testing is accomplished by the VSE attempting to gain unauthorized root access to a remote node. The VSE will attempt to connect to the remote node as the super-user and perform root functions. If the VSE can connect to the remote node as root or misuse an exisitng process on the remote node that gives the VSE root priviledges the VSE will create a new shell process that has the real and effective user ID, group IDs, and supplementary group list set to those of root. The new shell is then used to run commands on the remote node. The responses from the remote node are then recorded and a determination is made as either being positive or negative regarding if the administrative access can be obtaineded without proper authentication or with weak authentication.

HTTP Checks on Web Servers 14 are performed by the VSE creating a HTTP connection to a remote node on any port from 1 through 65536 that responds correctly to the HTTP connection request and then proceeds to serve up a web page. If the remote node responds back to the connection, then the VSE attempts to QUERY the server to determine what version of an HTTP server the remote node is running. The version returned from the QUERY string is then compared to the VSE program database of HTTP server versions that are known to have security problems. If the returned version matches then the node being tested, it is then recorded as positive.

Kerberos 15 vulnerability testing is accomplished by testing a remote node to see if it provides strong authentication for client/server applications via secret-key cryptography. The VSE attempts to communicate with a remote node by connecting to the kerberos daemon or ticket process and requesting a ticket fom the remote node. If the is presented with a ticket, it can then use this ticket, presenting it toapplications elsewhere in the network or on the remote node. The responses from the remote node are then recorded and a determination is made as either being positive or negative regarding if kerberos ticket can be obtained without proper authentication or with weak authentication.

Miscellaneous Security Vulnerability Testing 16 vulnerability testing is a component of the VSE where any tests that do not fall into one of the pre-defined component categories that are performed. An example of this is the VSE making a connection to a remote node and attempting to gain debug-level access on a system process. The responses from the remote node are then recorded and a determination is made as either being positive or negative regarding the particular responses for the associated tests.

NetBIOS 17 vulnerability testing is accomplished by the VSE attempting to retrieve all information available from the remote server using NetBIOS connection protocols and attempting to access any services provided by the server. The responses from the remote node are then recorded and a determination is made as either being positive or negative regarding if the NetBIOS services can be accessed without proper authentication or with weak authentication.

Network Service 18 vulnerabilities are tested by the VSE creating TCP/IP connections to a remote node on a range of ports from numbers 1 through 65536 and listening for an open connection. The responses from the remote node are then recorded and a determination is made as either being positive or negative if a particular service is found listening on a given port.

Network File System (NFS) 19 vulnerability testing is accomplished by the VSE attempting to retrieve all information available from the remote server using NFS connection protocols and attempt to access any services provided by the server. The responses from the remote node are then recorded and a determination is made as either being positive or negative regarding if the NFS services can be accessed without proper authentication or with weak authentication. Network Information Services (NIS) 20 vulnerability testing is accomplished by the VSE attempting to retrieve all information available from the remote server using NIS connection protocols and an attempt is made by the VSE to access any Network information Services provided by the remote node. The responses from the remote node are then recorded and a determination is made as either being positive or negative regarding if the NIS services can be accessed without proper authentication or with weak authentication.

Programming Language 21 vulnerability testing is accomplished by the VSE attempting to compromise the security of a remote node by attempt to filter in through a CGI opening or application program service and exploiting a security hole that may exist in a program written with a compiled or interpreted programming language. The VSE looks at four basic risks that include: Unauthorized access of documents stored at the remote nodes HTTP server document tree; Interception of transmitted user-to-server documents; Host machine specifications obtained for illicit purposes; and Bugs inherent to the language or program on the remote node that allow outsiders to execute commands on the remote node. The responses from the remote node are then recorded and a determination is made as either being positive or negative regarding if there are any programming language specific vulnerabilities existing on the remote node.

Port Scanning 22 is accomplished by the VSE creating TCP and UDP connections to a remote node on a range of ports from numbers 1 through 65536 and listening for an open connection. The VSE also employs a half-open port scan technique that only partially opens a connection, but stops halfway through. The VSE only sends the SYN packet to the remote node. This stops the remote node service from ever being notified of the incoming connection, however the VSE is still able to see which ports are open and thus records them. The responses from the remote node are then recorded and a determination is made as either being positive or negative regarding which ports were found to be open and have network services running on them.

Registry 23 attacks are performed only on Microsoft Windows™ operating system based devices and are tested by the VSE attemping to connect to the remote node and access or manipulate data contained in the systems registry. The VSE will attempt to see if everyone has remote access to a Windows NT systems registry by default. Windows NT 4.0 has a new registry key:

<HKEY_LOCAL_MACHINE\SYSTEM\CurrentContro\Set\Control\SecurePipeServers\Winreg>

If this key does not exist, remote access is not restricted, and only the underlying security on the individual keys control access. The VSE will also check to see if files on the remote node with ‘.reg’ extensions exist, files of this type will automatically write to the registry with current user privileges on open. This is a default action and the registry by default allows the group ‘Everyone’ access to many parts of the registry. The responses from the remote node are then recorded and a determination is made as to either being positive or negative regarding which ports were found to have registry access vulnerabilities.

Remote Monitoring 24 vulnerability testing is accomplished by the VSE attempting to remotely monitor a user or client session activities on the remote node by shadowing a TCP/IP connection or exploting a programming lamguage security hole in an application or service that is running on the remote node. If the VSE is able to monitor the remote node, it is then recorded as being positive.

Remote System Shell Access 25 vulnerability testing is accomplished by the VSE attempting to obtain an unauthorized shell connection from the remote node using the TCP/IP protocol. If a shell can be obtained from the remote node, it is then recorded as being positive.

Remote System Access 26 vulnerability testing is accomplished by the VSE attempting to gain access to the remote node using TCP/IP connection protocols and known holes in various application programs and operating system services. If access can be obtained from the remote node it is then recorded as being positive.

Remote Procedure Call (RPC) 27 services vulnerability testing is accomplished by the VSE attempting to retrieve all information available from the remote server using RPC connection protocols and attempt to access any services provided by the server. The responses from the remote node are then recorded and a determination is made as either being positive or negative regarding if the RPC services can be accessed without proper authentication or with weak authentication.

Simple Mail Transport Protocol (SMTP) systems 28 vulnerability testing is accomplished by the VSE attempting to retrieve all information available from the remote server using SMTP connection protocols and attempting to access any services provided by the server. The responses from the remote node are then recorded and a determination is made as either being positive or negative regarding if the SMTP services can be accessed without proper authentication or with weak authentication.

Simple Network Management Protocol (SNMP) systems 29 vulnerability testing is accomplished by the VSE attempting to retrieve all information available from the remote server using SNMP connection protocols and attempting to access any services provided by the server. The responses from the remote node are then recorded and a determination is made as either being positive or negative regarding if the SNMP services can be accessed without proper authentication or with weak authentication.

Standard Query Language (SQL) 30 vulnerability testing is performed by the VSE first determining if a SQL database is running or accessible on the remote node. If an SQL database is found, the VSE then will make a connection attempt to login to the database and access any information that may be obtainable. The next step the VSE does in testing in the SQL Server security is to test the permissions on objects in the database to determine who can (or can't) read (SELECT) or modify (INSERT, UPDATE, or DELETE) objects in the database, such as tables and views. The responses from the remote node are then recorded and a determination is made as either being positive or negative regarding any SQL vulnerabilites.

Secure Socket Layers (SSL) 31 vulnerability testing is accomplished by the VSE attempting to retrieve all information available from the remote server using SSL connection protocols and attempting to access any services provided by the server. The responses from the remote node are then recorded and a determination is made as either being positive or negative regarding if the SSL services can be accessed without proper authentication or with weak authentication.

System Backdoors 32 checks are to determine if a Trojan horse or backdoor program has been installed on the remote nodes being tested. A system back door check is executed by creating a TCP/IP connection to the remote node and testing for the existence of remote listeners that correspond to the port number of known backdoor programs. The response from the remote node is then recorded as either being positive or negative, that it did have a listener on a known backdoor port number or timed out and/or sent an error message back to the VSE application.

The TCP/IP Protocol Suite 33, which is very widely used today, has a number of serious security flaws inherent in the protocols, regardless of the correctness of any implementations. The VSE application performs a variety of attacks based on these flaws, including sequence number spoofing, routing attacks, source address spoofing, and authentication attacks. Some of these flaws exist because hosts rely on IP source address for authentication. Others exist because network control mechanisms, and in particular routing protocols, have minimal or non-existent authentication. When the VSE runs the tests it will attempt to gain control over a remote node and run through the series of attacks described above, the responses from the remote node is then recorded as either being positive or negative to the associated test.

X-Windowing Systems 34 utilize a Client-Server model of network communication. This model allows a user to run a program in one location, but control it from a different location. Counter to common client-server convention, the user actually works directly on the X server, which offers a screen, a keyboard, and a mouse. It's referred to as the server because it generates the inputs for and manages the outputs from the clients. The X clients are applications, such as xterm, emacs, or xclock. They receive and process inputs and return outputs. The clients that are able to run on a server should be carefully controlled. Since multiple clients are running on the same server, careful control of their inter-communication should be observed. The X-Windows vulnerability tests are performed by the VSE attempting to see if one client is able to send information to another client, or one client is able to capture information meant for another client, the system may be vulnerable. The response from the remote client is then recorded as either being positive or negative

Network Security Vulnerability Testing

The Network Security Vulnerability Testing (NSVT) application 41 is a complete system designed for testing the vulnerability of computers and networks to unauthorized entry. The NSVT 41 consists of eight application program modules that make up the complete application. The separate application modules are as follows: Secure Login of a remote client to the VSE; Discovery of nodes that are on a network, and the Profiling of what type of node is on a network and what Operating System that node is running; Interrogation of a node by performing auditing tests to assess the security vulnerabilities of that given node; Exploit the vulnerabilities found on computer and network systems; An automated phone dialer to determine what phone numbers in a given range of exchanges may have modems and network nodes attached to them; An analysis of the network traffic and protocol that are running between the remote Client running the application and the Server performing the vulnerability scans; A Security Tests database with an embedded search and retrival system; and Reporting and tracking of the information collected after a vulnerability scan is run for a given network.

There are two primary databases in the NSVT 41, whose definitions are as follows: Control database 50—Houses Account and Network information for each client; Maintains all jobs that were run for a particular client network and CVE (security testing) database 100—Houses the Common Vulnerabilities & Exposures information, including assigned categories, risk factor, corrective actions, and affected Operating Systems.

NSVT 41 is comprised of several modules which provide the primary functionality. They are the following:

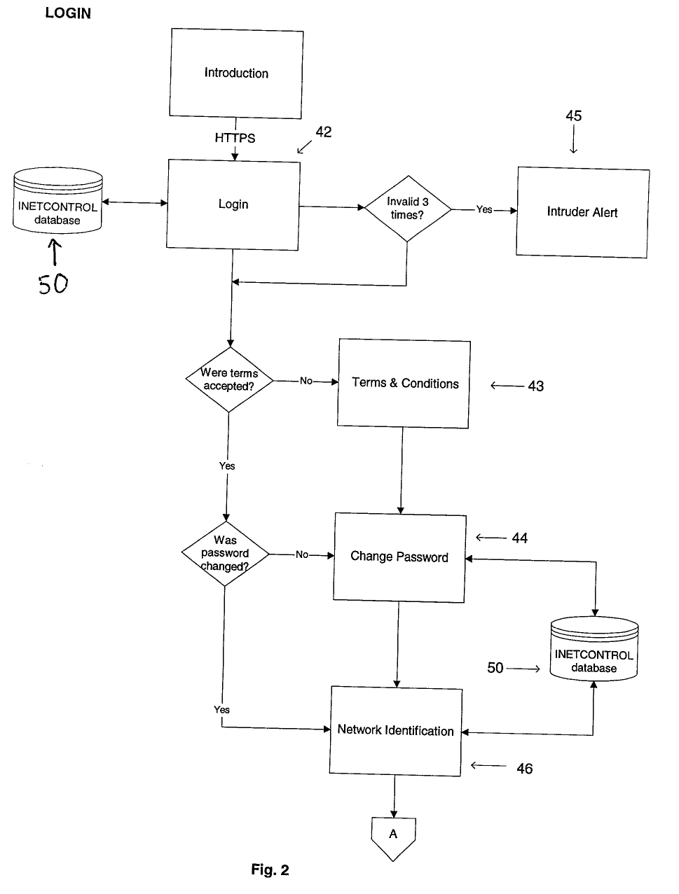

In FIG. 2, the Login VSE Application 42 (L-VSE or Login) first runs the login process, then communicates with the application control database 50 and the client running the tests. The login application's primary purpose is to authenticate the remote client connection running the NSVT application 41. Client authentication requires the user to input their username, password and network address 46 that they are registered in the VSE control database to perform vulnerability testing. The user must first accept the terms and conditions agreement 43 presented to them and upon their very first login to the NSVT 41 using the password supplied to them by Network Security Systems. At this point, the login application 42 verifies the client and prompts them to change their initial password 44. After successful completion of the password change, the NSVT application 41 continues. Upon any subsequent client login, the L-VSE 42 checks to see if the terms were accepted and if the initial password was changed. If, after three attempts a bad username, password and/or network address were entered the client connection is rejected from the server and an intruder alert message 45 is displayed. Please refer to FIG. 2 for additional details.

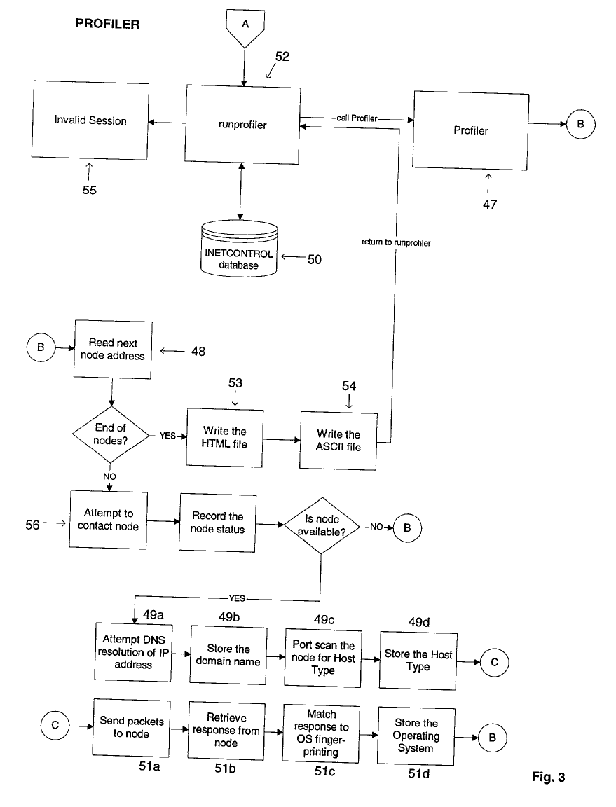

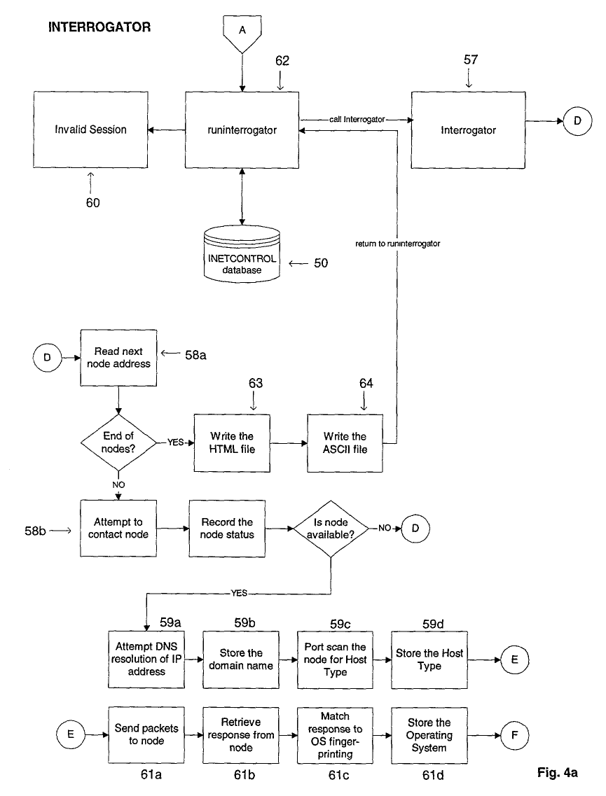

In FIG. 3, the Discovery VSE Application 52 (Discovery) is built into the profiler application 47 and is used to discover what nodes are on a network by sending ICMP echo-requests, open TCP or UDP port requests and listening for a reply from the remote node being tested. If the remote node responds to any of the three types of requests the test is recorded positive and the node and it's associated IP address are recorded as being available on the network 53, 54. If the node does not respond to any of the three types of requests, an invalid session 55 is displayed.

Also in FIG. 3, the Profiler VSE Application 47 (P-VSE or Profiler) first runs the discovery process, then communicates with the application control database 50 and the client running the tests. The profiler application's primary purpose is to determine what type of node and what type of Operating System (OS) that node is running. The P-VSE 47 will use as input a single node IP address 48 or a range of IP addresses. First, the P-VSE 47 attempts 56 to contact the node through three different methods (ICMP echo-request, open TCP port, open UDP port) to see if the node is available. If the node is available, it attempts to resolve the nodes IP address into a valid host name through DNS resolution 49a-d, then sends TCP packets to a listening port on a remote and retreiving and analyzing the response packets that come back from that node 51a-d.

The P-VSE 47 sends 7 packets (0-6), and compares the responses with the OS finger printing 51c configuration file, which is where the different Operating Systems are described in a response-based way to each packet (differentiated by the destination port).

The seven packets sent by the P-VSE 47 are as follows:

0 SYN

1 SYN+ACK

2 FIN

3 FIN+ACK

4 SYN+FIN

5 PSH

6 SYN+XXX+YYY

All packets have a random seq_num and a 0×0 ack_num. On response to to packet 0 (SYN), any LISTEN port must answer a SYN+ACK with a nonzero ack_num, seq_num and window, or in case of not being LISTEN, a TCP/IP based node will send back a RST+ACK with the valid ack_num. Please refer to FIG. 3 for additional details.

In FIG. 4a, the Interrogator VSE Application 57, 62 (I-VSE or Interrogator) communicates with the application control database 50 and the client running the tests. The interrogator application's primary purpose is to perform the auditing tests to assess the security vulnerabilities of computer and network systems. The I-VSE 57, 62 will use as input a single node IP address 58a or a range of IP addresses. First, the I-VSE 57, 62 attempts 58b to contact the node through three different methods (ICMP echo-request, open TCP port, open UDP port) to see if the node is available. If the node is available, it attempts to resolve the nodes IP address into a valid host name through DNS resolution 59a-d, then sends TCP packets to a listening port on the remote node and retrieving and analyzing the response packets that come back from that node 61a-d. Once, the I-VSE 57, 62 knows what type of Operating System it is communicating with it uses this information to run the associated tests. If the node does not respond to any of the three types of requests, an invalid session 60 is displayed. If the remote node responds to any of the three types of methods the test is recorded positive and the node and it's associated IP address are recorded as being available on the network 63, 64.

In FIG. 4b, the I-VSE 57, 62 also receives input from the remote client running the NSVT application 41 as to what type of vulnerability test suite (VTS) 106 it should run. Once, the I-VSE 57, 62 determines the type 65 of VTS 106 it should run, it begins to perform each test and record 63, 64 the output data that each VTS 106 module provides. Please refer to FIGS. 4a & 4b for additional details and the Vulnerability Testing System Components section above for details and operations of each VTS 106 component.

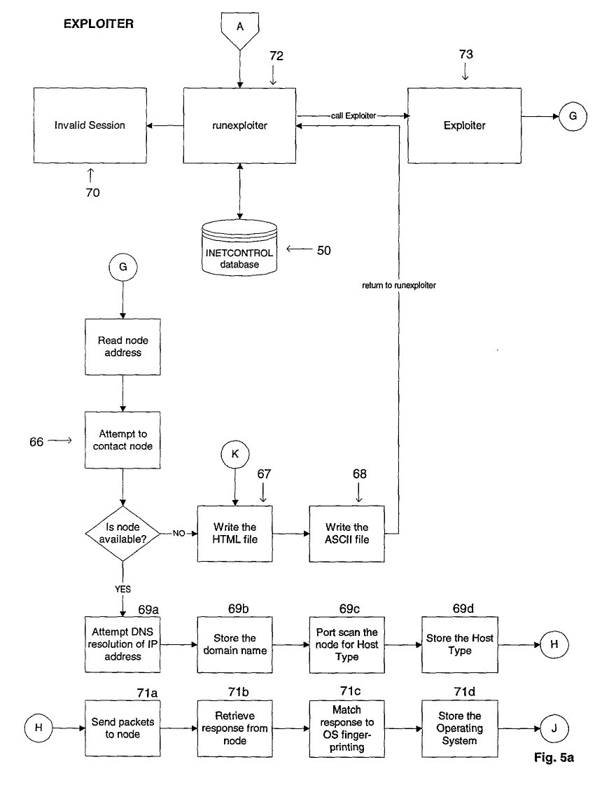

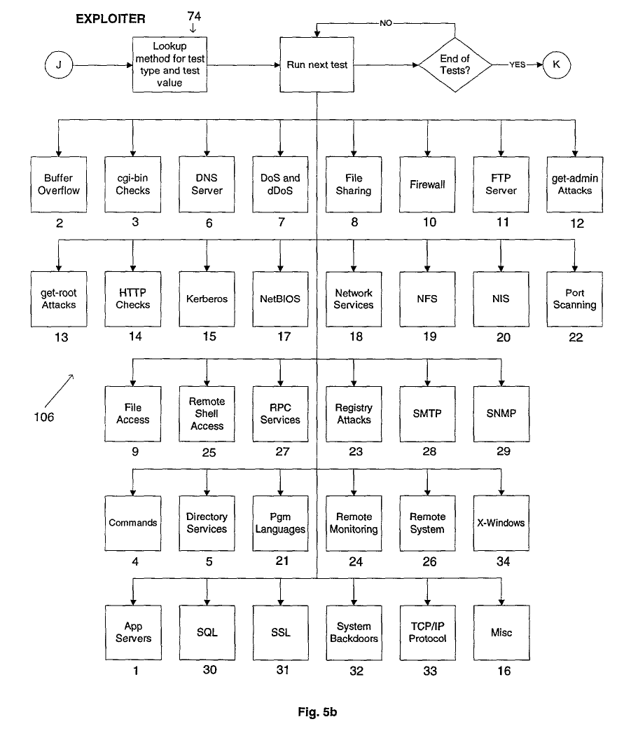

In FIG. 5a, the Exploiter VSE Application 72, 73 (E-VSE or Exploiter) communicates with the application control database 50 and the client running the tests. The exploiter application's primary purpose is to perform optional auditing tests to exploit the vulnerabilities found on computer and network systems. The E-VSE 72, 73 will only use single node IP. First, the E-VSE 72, 73 attempts 66 to contact the node through three different methods (ICMP echo-request, open TCP port, open UDP port) to see if the node is available. If the node is available, it attempts to resolve the nodes IP address into a valid host name through DNS resolution 69a-d, then sends TCP packets to a listening port on the remote node and retreiving and analyzing the response packets that come back from that node 71a-d. Once the E-VSE 72, 73 knows what type of Operating System it is communicating with it uses this information to run the associated tests. If the node does not respond to any of the three types of methods, an invalid session 70 is displayed.

In FIG. 5b, the E-VSE 72, 73 also receives input from the remote client running the NSVT application 41 as to what type 74 of exploit vulnerability test suite (VTS) 106 it should run. Once the E-VSE 72, 73 determines the type of exploit VTS 106 it should run, it begins to perform each test and record the output data that each VTS 106 module provides. Please refer to FIGS. 5a & 5b for additional details and the Vulnerability Testing System Components section of this document for details and operations of each VTS 106 component.

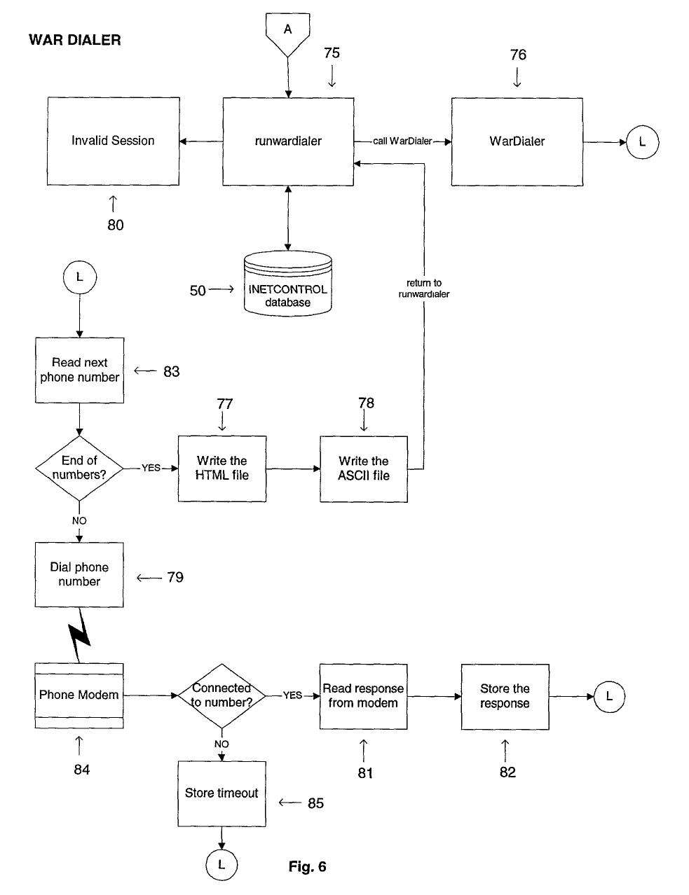

In FIG. 6, the War Dialer VSE Application 75, 76 (W-VSE or War Dialer) communicates with the application control database 50 and the client running the tests. The war dialer application's primary purpose is an automated way of dialing an area code, exchange 79, 83 and range of numbers within that exchange to determine if some kind of carrier or tone rather than a standard voice line can be found within the range of given numbers.

The W-VSE 75, 76 is capable of dialing all 10000 numbers (0000-9999) for a given exchange by:

1. Testing the analog lines within a PBX or range of phone numbers.

2. Finding any loops or milliwatt test numbers.

3. Finding any dial-up long distance carriers.

4. Finding any number that would give us a constant tone, or finding something that our calling modems would recognize as one.

5. Finding any tones (modems, terminal servers, etc.)

6. Determining within a given set range of telephone numbers or PBX extensions what number(s) a modem or terminal server could be found 81, 82, 84.

The W-VSE 75, 76 makes a determination as to what type of telecommunictions device is on the other end by analyzing 77, 78 the result code returned to the W-VSE 75, 76 by the phone number it connected to. The definitions of the dialer results codes are as follows:

TIMEOUT 85, The number was dialed, it rang ONCE and then it timed out without finding anything.

MODEM (In question), The number was dialed, it rang and then timed out using the TimeWaitDelay flag. The system type was unable to be determined and is in question.

NO DIALTONE or DID, War dialer tried to dial, there was no dial tone found (for the number it called). The war dialer then tries the same number again, until it has reached the maximum number of attempts.

BUSY, This means the number dialed was busy. All busy numbers and collected at the end of a run for a given range and then tried again. If a busy is still found after the second attempt, the war dialer moves on to the next previous busy in the range and then makes a final attempt from the beginning of the list. If after three attempts a busy is still found, it is then logged.

CONNECT, The war dialer found a tone. It is probably either a loop, PBX, or dial-up Long Distance (LD) carrier.

CARRIER, The war dialer found a carrier. An attempt was made by the war dialer to determine if it is a DATAKIT dialup, UNIX dialup, other determinable carrier or a do-nothing carrier. The results are then reported.

VOICE, The war dialer detected a voice answer or recorded message, if tone or carrier was first detected.

RINGOUT, This means “NumberMaxRings” was reached and the dial was aborted. (default is 7)

BLACKLISTED, This means the number was intentionally excluded in the War Dialer setup, therefore it was not dialed.

If the CONNECT dialer result code is received for a given number within an exchange and this option is checked, then an attempt is made by the war dialer to determine what type of system it has dialed into and several brute force default logins and passwords are tried for exploitation. Please refer to FIG. 6 for additional details. If the phone number does not respond to any of the three types of requests, an invalid session 80 is displayed.

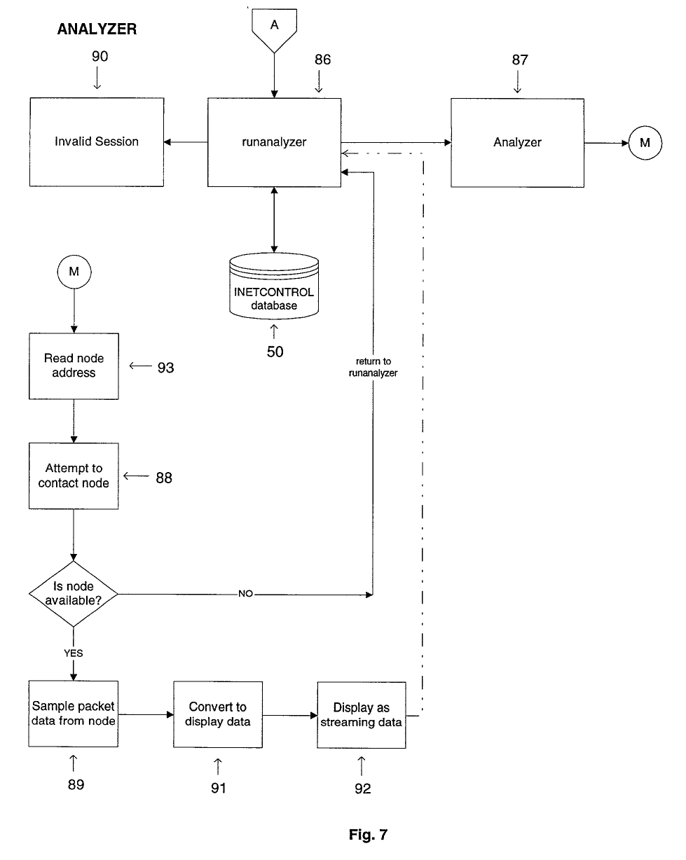

In FIG. 7, the Analyzer VSE Application 86, 87 (A-VSE or Analyzer) communicates with the application control database 50 and the client running the tests. The analyzer application's primary purpose is to analyze the network traffic and protocol from a remote node. The A-VSE 86, 87 receives input 93 from the remote client running the NSVT application 41 as to the IP address of the remote node it should attempt to analyze network traffic. Once, the A-VSE 86, 87 determines the node from which to analyze network traffic, it attempts 88 to contact the node through three different methods (ICMP echo-request, open TCP port, open UDP port) to see if the node is available. If the node is available, it attempts to resolve the nodes IP address into a valid host name through DNS resolution, then begins to sample packet data 89 coming from that node back to a network interface on the A-VSE 86, 87 server. The A-VSE 86, 87 then converts 91 this data into ASCII, BINARY or HEX format and displays the information back as streaming data 92 to the remote client interface. Please refer to FIG. 7 for additional details. If the node does not respond to any of the three types of methods, an invalid session 90 is displayed.

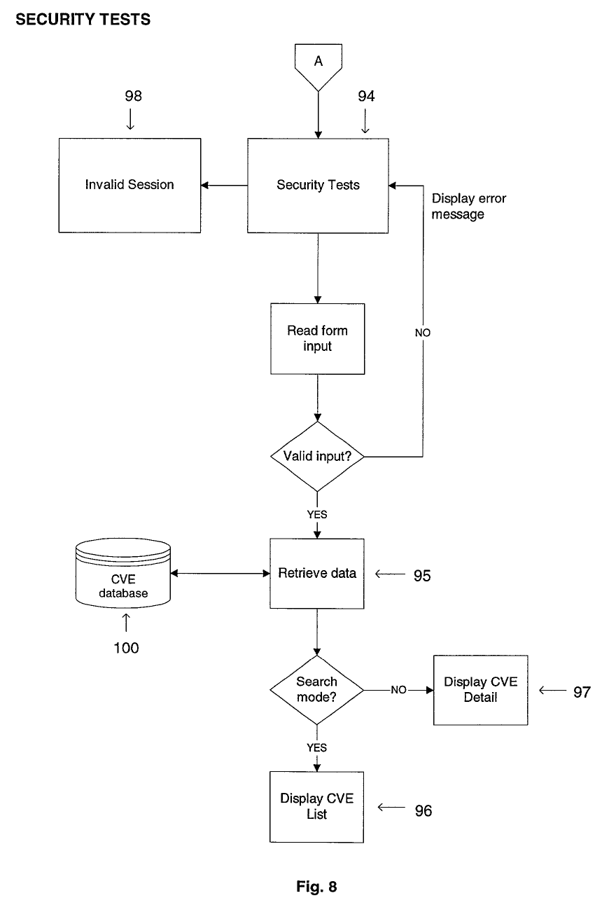

In FIG. 8, the Security Tests VSE Application 94 (S-VSE or Security Tests) communicates with the application control database 50 and the client running the tests. The Security Tests application's primary purpose is to provide a remote client with search and retrival access 95, 96, 97 of the CVE (security testing) database 100. Please refer to FIG. 8 for additional details. If the input is invalid, an invalid session 98 is displayed.

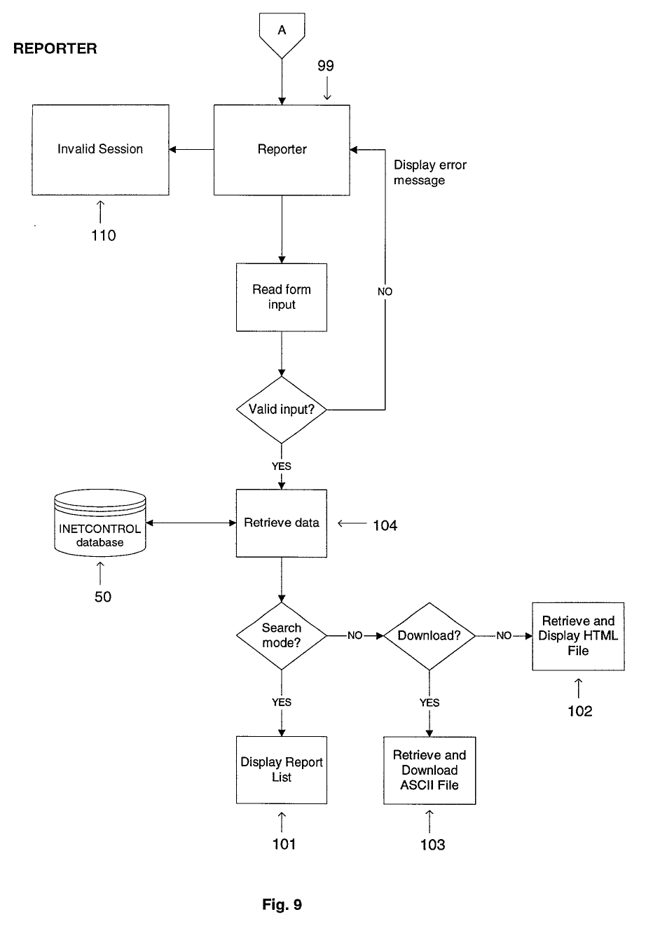

In FIG. 9, the Reporter VSE Application 99 (R-VSE or Exploiter) communicates with the control database 50 and the client running or searching for any reports. The reporter application's primary purpose is to provide a remote client with the ability to view corrective actions 101 and details 102, 103 of the found vulnerabilites on their network from running the NSVT application 41. The R-VSE also tracks all reports that were run for a given network and gives the remote client search and retrieval access to all of those reports. If the input is invalid, an invalid session 110 is displayed.

Once security penetration testing completes, a recommendation report revealing the results is automatically delivered to the user. This can be delivered through email, traditional mail or directly online through a secure Internet browser. This report provides the user with detailed results of penetration attempts made and any vulnerabilities that may exist. Informed decisions can then be made for corrective action.

Once any vulnerabilities are exposed by way of the recommendation report and corrective actions are taken based on this report, penetration testing can be performed once again to verify the fixes really perform as expected. Using this method of test, correct, and re-test creates a full proof security lock that verifies the systems are up to user's standards. Real world unbiased testing and reporting is what most companies desire for their computer networks.

In one preferred embodiment that is particularly suited to the present invention, an external Internet-based NSVT application 41 is utilized. In this configuration, the firewall 37 and other hosts as well as the subnetwork 39, 40 are tested for vulnerabilities to external threats such as computer hackers or unauthorized entry.

In another preferred embodiment of the present invention, an internal NSVT 38 is utilized. In this configuration the subnetwork 39, 40 is tested for vulnerabilities to internal exploits or unauthorized entry.

It is envisioned that the combination of the external Internet-based NSVT application 41 and the internal NSVT application 38 will allow IT Managers, Systems Administrators, Network Managers, and Internal Audit personnel to quickly and easily evaluate a company's external and internal network security; perform security vulnerability scans every time new vulnerabilities are identified; develop the skills necessary to perform network security vulnerability assessments eliminating the need for outside consultants and audits; and reduce their IT infrastructure costs through reduction in hardware, software, and training expenses. Thus, the combination of both NSVT's 38, 41 provides a mechanism for preventing vulnerabilities to computer networks, especially when it comes to computer hackers and unauthorized entry into a computer network.

Advantages of each of these embodiments will be readily understood. For example, the preferred embodiment may be utilized for electronic commerce (e-Commerce) and more and more business services being run over the Internet (e-Business). The continued expansion of the Internet, virtual private networks, and electronic commerce will be the key factor driving widespread and rapid growth of network security penetration and vulnerability testing software.

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. A method of determining computer network vulnerability comprising the steps of:
accessing a network security system through an encrypted connection;
testing for vulnerabilities of an independent computer network by utilizing said network security system;
storing any found vulnerabilities of said independent computer network into a user database for review and analysis;
correcting said found vulnerabilities; and
re-testing said found vulnerabilities of said independent computer network to verify the correcting step.

2. The method of claim 1, further comprising the step of:
continuously updating said found vulnerabilities into said user database of said network security system for future testing.

3. The method of claim 2, wherein said vulnerabilities consist of any computer hacking and unauthorized entry.

4. The method of claim 1, wherein said network security system is internal to said independent computer network.

5. The method of claim 1, wherein said network security system is external to said independent computer network.

6. The method of claim 1, wherein said network security system is Internet-based.

7. A network security system comprising:
a database containing vulnerabilities and account data specific to each user;
a secure socket layer connection between said network security system and said user;
a login application which authenticates said user;
a network identifier application which manages socket connections and communications/messages between applications;
a profiler application which communicates with said database and the user through said network identifier application in order to update said database; and
an interrogator application which communicates with said database,
wherein, said interrogator application identifies through tests vulnerabilities of a computer network,
wherein, said profiler application determines what type of node and what operating system said node is using.

8. The network security system of claim 7, further comprising:
an exploiter application which communicates with said database and the user in order to test for and to identify additional vulnerabilities.

9. The network security system of claim 7, further comprising:
a dialer application which communicates with said database and the user in order to identify vulnerabilities of a user's Internet connectivity and telecommunication infrastructure.

10. The network security system of claim 7, further comprising:
an analyzer application which checks network traffic and protocols.

11. The network security system of claim 7, further comprising:
a reporter application which communicates with said database and the user.

12. The network security system of claim 11, wherein said reporter application communicates with a report display and a report download connection.

13. The network security system of claim 12, further comprising:
a security test application which communicates with a Common Vulnerabilities and Exposures display and a Common Vulnerabilities and Exposures database.

14. The network security system of claim 13, wherein said Common Vulnerabilities and Exposures database includes assigned categories, risk factors, corrective actions and affected operating system information for comparison with said reporter display and said report download data.

15. The network security system of claim 7, wherein said network security system is Internet-based.

16. The network security system of claim 7, wherein said network security system is internal to said computer network.
